(19) United States
(12) Patent Application Publication
(10) Pub. No.: US 2017/0344996 A1
(43) Pub. Date: Nov. 30, 2017

(54) Systems and Methods for Use in Reporting Recovery of Disabled Account Devices

(71) Applicant: MASTERCARD INTERNATIONAL INCORPORATED, Purchase, NY (US)

(72) Inventors: Claire Le Gal, New York, NY (US); Gregory S. Phillips, St. Louis, MO (US)

(21) Appl. No.: 15/168,964

(22) Filed: May 31, 2016

(51) Int. Cl. G06Q 20/40; G06Q 20/14; G06F 21/36

(52) U.S. Cl. CPC G06Q 20/405; G06F 21/36; G06Q 20/14

(57) ABSTRACT

Systems and methods are provided for recovering and reporting account devices associated with payment accounts, for example, when the devices have been compromised. One exemplary method includes receiving a request to report recovery of a compromised account device, causing an interface to be displayed to a recovering entity of the device, and populating data fields in the interface based on an identifier of the device included in the request. The method also includes receiving a submission comprising responses to the data fields, by the recovering entity, and receiving an image of the device in an unusable form. The method then further includes storing the submission and image to a data structure, as proof that the device has been recovered. The method may then include notifying an issuer, associated with the device, of the recovery, so that the issuer can access the information related thereto and update its records accordingly.

### FIELD

The present disclosure generally relates to systems and methods for use in reporting recovery of disabled account devices, and in particular, to providing electronic recovery interfaces (e.g., forms, etc.) or other mechanisms through which recovering entities are able to report (and, in some cases, verify) recovery of the disabled account devices.

### BACKGROUND

This section provides background information related to the present disclosure which is not necessarily prior art.

Payment accounts are used by consumers to perform numerous different transactions including, for example, purchasing products (e.g., goods and/or services) from merchants, etc. Credentials for use of payment accounts are known to be provided to merchants in the form of payment devices (broadly, account devices), such as, for example, credit cards or fobs associated with the payment accounts. It is known that certain events, such as theft or fraud of the credentials, for example, may cause the payment devices to be disabled, after which the issuers or other entities may attempt to recover the payment devices. In one example, when a consumer attempts to use a disabled payment device at a merchant, the issuer of the payment device is known to instruct the merchant to recover the payment device if it is safe to do so. After recovery of the payment device, the merchant is expected to inform the issuer, or other entity, of the successful recovery, and to return the payment device to the issuer (or other entity).

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in reporting recovery of disabled account devices;

FIG. 2 is a block diagram of a computing device that may be used in the exemplary system of FIG. 1;

FIG. 3 is an exemplary method, which may be implemented in connection with the system of FIG. 1, for reporting recovery of a disabled account device associated with a payment account; and

FIGS. 4-5 are exemplary recovery interfaces including forms, which may be used in connection with the system of FIG. 1 and/or the method of FIG. 3, to report recovery of a disabled account device.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Account devices, such as credit cards, debit cards, fobs, and the like, are often associated with payment, banking, and/or other accounts, and may be the targets for theft and/or fraud. When an account device (and the underlying account) is compromised, an issuer of the account device (or others associated therewith) typically puts in place processes by which the account device is disabled and recovery is attempted, whereby the account device is removed from circulation. Uniquely, the systems and methods herein permit efficient reporting of the recovery of a disabled account device. In particular, upon recovery of the account device, at a merchant, for example, the merchant and/or its associated acquirer interacts with a recovery engine to report recovery of the account device (e.g., via means provided by the recovery engine such as interactive interfaces, electronic forms, etc.). In addition, electronic recovery forms, when provided to the recovering entity (e.g., to the merchant and/or the acquirer, etc.) by the recovery engine, may be pre-populated with known data (based on an identifier associated with the recovered account device) to reduce the effort and/or time required for the recovering entity to complete and submit the recovery forms. When completed (which often requires including an image of the recovered account device), the form(s) is/are submitted and acts as proof that the account device is removed from circulation. In response to the submitted form(s), the recovery engine may coordinate fees among participating entities (e.g., the issuer associated with the account device, the entity associated with recovering the account device, etc.), and further may notify the issuer of the recovery of the account device. As such, reporting of recovery is facilitated in an efficient (and verified) manner, whereby return of the disabled device may be unnecessary.

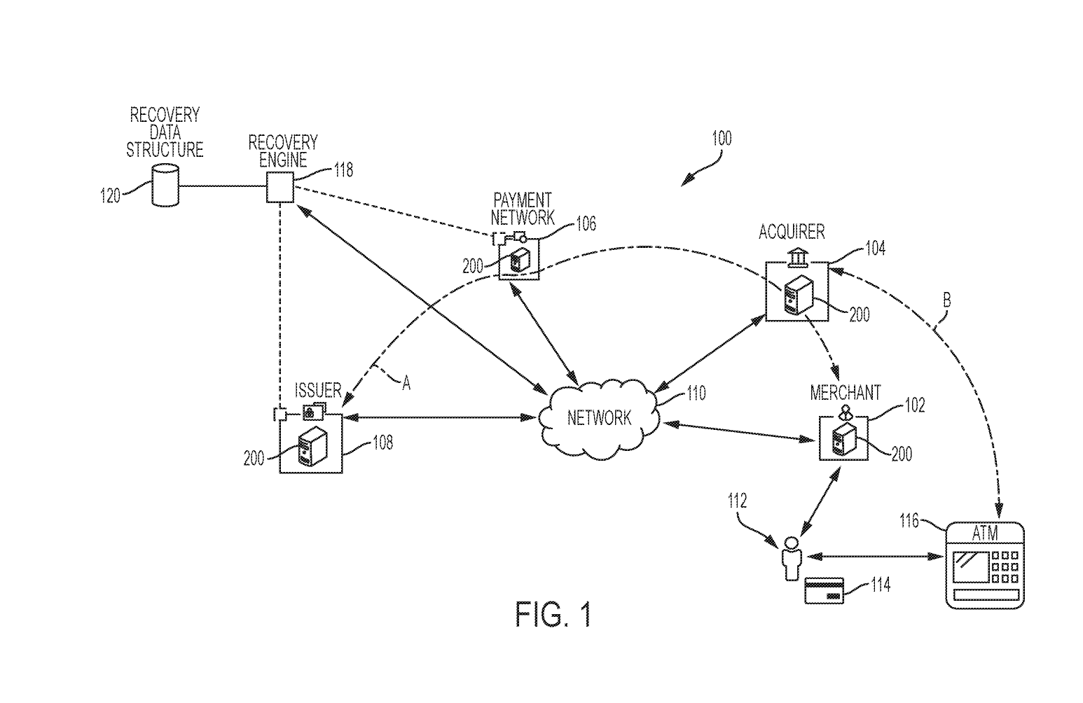

FIG. 1 illustrates an exemplary system 100, in which the one or more aspects of the present disclosure may be implemented. Although the system 100 is presented in one arrangement, other embodiments may include the parts of the system 100 (or other parts) arranged otherwise depending on, for example, entities involved in processing account transaction, implementation of a recovery engine to facilitate reporting of disabled (and recovered) account devices, etc.

The illustrated system 100 generally includes a merchant 102, an acquirer 104, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirer 104 and the issuer 108 and, separately, the public Internet, which may provide interconnection between the merchant 102, the payment network 106, the acquirer 104, and a consumer 112, etc. as desired

The merchant 102 is generally associated with products (e.g., goods and/or services, etc.), which are offered for sale and are sold to consumers in the system 100, including consumer 112. The merchant 102 may offer the products for sale in physical and/or virtual locations (e.g., brick-and-mortar locations, website locations, or web-based store front locations, etc.), as desired.

Further, the consumer 112 is able to fund transactions with the merchant 102 for one or more of the products, for example, via a payment account, associated with (and issued to the consumer 112 by) the issuer 108. In addition, the consumer 112 is in possession of an account device 114 (issued by the issuer 108), which is associated with the payment account. While the account device 114 is associated with the payment account in this embodiment, it may be associated with another type of account in other embodiments, including, for example, a savings account, etc. Moreover, because the account device 114 is associated with the payment account, the account device 114 may further be understood to be a payment device, which may include for example, a credit card, a debit card, a fob, a smartcard, etc. With that said, while a smartphone or other consumer-owned device may also traditionally be employed as an account device, as used herein the term “account device” is generally directed to an account device issued and/or otherwise provided by the issuer 108, whereby confiscation and/or recovery of the device avoids any property of the consumer 112 (e.g., a smartphone, a tablet, or other personal device, etc.).

With continued reference to FIG. 1, in an example transaction in the system 100, the consumer 112 initiates a purchase with the merchant 102 for a product by presenting the account device 114 to the merchant 102. In turn, the account device 114 is swiped or otherwise presented to a point of sale (POS) terminal of the merchant 102. The merchant 102 then submits an authorization request to the acquirer 104 (associated with the merchant 102) for the transaction. The authorization request is transmitted along path A in the system 100, as referenced in FIG. 1. The acquirer 104 communicates the authorization request with the issuer 108 (associated with the consumer's payment account) through the payment network 106, such as, for example, through MasterCard®, VISA®, Discover®, American Express®, etc., to determine whether the payment account is in good standing and whether there are sufficient funds and/or credit to cover the transaction. In turn, if approved, an authorization reply or response (indicating the approval of the transaction) is transmitted back from the issuer 108 to the merchant 102, along path A, thereby permitting the merchant 102 to complete the transaction. The transaction is later cleared and/or settled (via appropriate transaction messages such as clearing messages and/or settlement messages) by and between the merchant 102, the acquirer 104, and the issuer 108 (by appropriate agreements). If declined, however, the authorization reply indicates a decline of the transaction, thereby permitting the merchant 102 to halt or terminate the transaction, or request an alternate form of payment.

In another example transaction in the system 100, the consumer 112 initiates a withdrawal and/or deposit of money to the consumer's payment account at an automated teller machine (ATM) 116 by inserting, scanning and/or otherwise providing the account device 114 to the ATM 116. In turn, the ATM 116 submits an authorization request, similar to path A described above, to the issuer 108 (when the account is associated with the issuer 108), upon which the deposit and/or withdrawal is performed. Alternatively, the ATM 116 may submit an authorization request to the acquirer 104, along path B in FIG. 1 (for example, when the acquirer 104 is the operator of the ATM 116). The acquirer 104 then transmits the authorization request to the issuer 108, via the payment network 106, to determine whether the payment account is in good standing and whether there is sufficient funds in the account for a withdrawal transaction (or whether the payment account is of sufficient standing to accept deposits). The transaction is further subject to messaging similar to that described above with reference to path A, for example, for clearing and/or settlement of the ATM transaction.

In one or more instances, the account device 114 may be disabled by the issuer 108, for example, because of a theft or fraud condition related to the account device 114 (and/or related to a credential associated with the consumer's underlying payment account). In so doing, the issuer 108 may request that the merchant 102 (or the ATM 116 or another entity), when involved in an attempted subsequent transaction by the consumer 112 using the account device 114, recover the account device 114 in addition to declining the transaction. In particular, when the account device 114 is “disabled” and listed for recovery by the issuer 108, the issuer 108 responds to an authorization request involving a transaction initiated with the account device 114 with a particular reply, for example, an authorization advice (or message) comprising a 0120 ISO 8535 message having a response code of “04” in data element (DE) 39. When the authorization advice is received by the POS terminal at the merchant 102, as in the first above example transaction, with “04” in DE 39, a message is displayed or otherwise provided to the merchant's employee/manager (or other person associated with merchant 102), for example, with instructions to “recover” the account device 114, if safe to do so. Similarly, when the ATM 116 is the originator of the authorization request, as in the above second example transaction, the ATM 116 understands the authorization advice and maintains the account device 114 within the machine (if inserted therein). It should be appreciated that other messages, consistent with the ISO 8583 standard, or otherwise, may be utilized in the system 100 to direct and/or request that the merchant 102 and/or the ATM 116 (and/or another entity) recover the account device 114 when used therewith in a transaction, etc.

In the above example transactions, transaction data is generated, collected, and stored as part of the above interactions among the merchant 102, the ATM 116, the acquirer 104, the payment network 106, the issuer 108, and/or the consumer 112 (and included in the various transaction messages). The transaction data represents at least a plurality of transactions (e.g., purchase transactions, withdrawal transactions, deposit transactions, attempted transactions, etc.), and includes, for example, authorization, clearing and/or settlement data, etc. The transaction data, in this exemplary embodiment, is stored at least by the payment network 106 (e.g., in a data structure associated with the payment network 106, etc.). Additionally, or alternatively, the merchant 102, the acquirer 104, the issuer 108, and/or the ATM 116 may store the transaction data, or part thereof, in a data structure, or transaction data may be transmitted between parts of system 100 as used or needed. With that said, transaction data may include, for example, primary account numbers (PANs) for consumers involved in the transactions, amounts of the transactions, merchant IDs for merchants involved in the transactions, merchant category codes (MCCs), dates/times of the transactions, products purchased and related descriptions or identifiers, account balances, etc. It should be appreciated that more or less information related to transactions, as part of either authorization or clearing and/or settlement, may be included in transaction records and stored within the system 100, at the merchant 102, the acquirer 104, the payment network 106, the issuer 108, and/or the ATM 116.

In various exemplary embodiments, consumers (e.g., consumer 112, etc.) involved in the different transactions herein agree to legal terms associated with their payment accounts, for example, during enrollment in their accounts, etc. In so doing, the consumers may voluntarily agree, for example, to allow merchants, ATMs, issuers, payment networks, acquirers, etc., to use data collected during enrollment and/or collected in connection with processing the transactions, subsequently, for one or more of the different operations described herein.

While only one merchant 102, one consumer 112, one account device 114, and one ATM 116 are illustrated in FIG. 1, for ease of reference, in other embodiments multiple merchants, consumers, account devices, and/or ATMs may be included in the system 100. Further, while one acquirer 104, one payment network 106, and one issuer 108 are illustrated in FIG. 1, it should be appreciated that any number of these entities/devices (and their associated components) may also be included in the system 100, or may be included as a part of systems in other embodiments, consistent with the present disclosure.

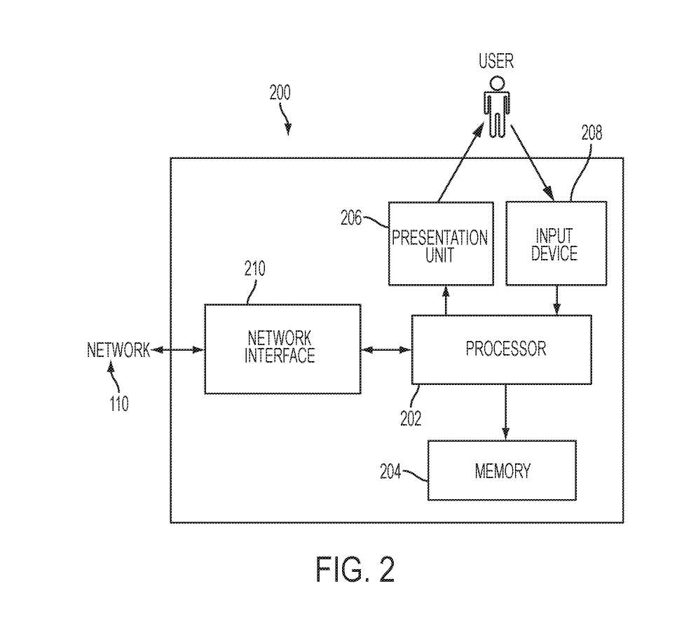

FIG. 2 illustrates an exemplary computing device 200 that can be used in the system 100. The computing device 200 may include, for example, one or more servers, workstations, personal computers, laptops, tablets, smartphones, PDAs, ATMs, POS terminals, etc. In addition, the computing device 200 may include a single computing device, or it may include multiple computing devices located in close proximity or distributed over a geographic region, so long as the computing devices are configured to function as described herein. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, each of the merchant 102, the acquirer 104, the payment network 106, and the issuer 108 are illustrated as including, or being implemented in, computing device 200, coupled to the network 110. In addition, the ATM 116 illustrated in FIG. 1 may be considered a computing device consistent with computing device 200.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the operations described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, account information, recovery form interfaces, recovery data for account devices, fee schedules, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

In the exemplary embodiment, the computing device 200 also includes a presentation unit 206 that is coupled to (and in communication with) the processor 202 (however, it should be appreciated that the computing device 200 could include output devices other than the presentation unit 206, etc.). The presentation unit 206 outputs information (e.g., recovery form interfaces, etc.), visually, for example, to a user of the computing device 200 (e.g., users associated with one or more of the merchant 102, the acquirer 104, the payment network 106, and/or the issuer 108; etc.). It should be further appreciated that various interfaces (e.g., as defined by web-based applications, websites, etc.) may be displayed at computing device 200, and in particular at presentation unit 206, to display certain information to the user (e.g., one or more of the forms and data related thereto as described herein, etc.). The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

In addition, the computing device 200 includes an input device 208 that receives inputs from the user (i.e., user inputs) such as, for example, disabled account device and/or recovery details, etc. The input device 208 may include a single input device or multiple input devices. The input device 208 is coupled to (and in communication with) the processor 202 and may include, for example, one or more of a keyboard, a pointing device, a mouse, a stylus, a card reader, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit and an input device.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. In some exemplary embodiments, the computing device 200 includes the processor 202 and one or more network interfaces incorporated into or with the processor 202.

Referring again to FIG. 1, the system 100 includes a recovery engine 118 and a recovery data structure 120. As illustrated, the recovery engine 118 and recovery data structure 120 are stand-alone parts of the system 100 and, as described herein, are implemented via the payment network 106. In connection therewith, the recovery engine 118 is consistent with computing device 200 (with the recovery data structure 200 either associated with memory 204 of the computing device, or separate therefrom), and is in communication with network 110. However, as indicated by the dotted lines, the recovery engine 118 (and the data structure 120, as appropriate) may be integrated and/or included, in whole or in part, with the payment network 106, as desired. Alternatively, or in addition, the recovery engine 118 and recovery data structure 120 may be implemented via, and/or integrated and/or included in whole or in part with, the issuer 108, as also shown by the dotted lines in FIG. 1.

The recovery data structure 120 stores recovery processing information and data, including, for example, data associated with account devices to be recovered, recovery interfaces and associated forms, etc. The interfaces and associated forms, for example, define the data requested from recovering entities for completion of the process of recovering account devices. Such data may include, without limitation, account numbers associated with devices to be recovered (e.g., PANs, etc.), names of the recovering entities (e.g., a name of merchant 102, etc.), contact information associated with the recovering entities, methods of recovery, circumstances of recovery, proof of account device possession and/or destruction following recovery, etc. The data may be organized, in the recovery forms, into one or more different sections or tabs with certain data designated as required/optional, into one or more sections for attaching files and/or other documents and the like for submission to the recovery engine 118, etc. The data structure 120 further includes previous submissions from recovery entities.

In the system 100, the recovery engine 118 is configured to provide the interfaces to recovering entities, for use in soliciting the data from the recovering entities to populate the recovery forms. In connection therewith, the interfaces may include, for example, electronic recovery forms, which may be populated by the recovery entities and then submitted to report the recovery. In particular, after recovering an account device (e.g., account device 114, etc.), the merchant 102, a bank/entity associated with the ATM 116, or other recovering entity requests to report the recovery to the recovery engine 118 (e.g., via a web-based application, website, etc. supported by the recovery engine 118, etc.). In turn, the recovery engine 118 is configured to cause one or more of the interfaces to be displayed to the recovering entity, and to receive inputs from the recovering entity via the interfaces (e.g., via the electronic recovery forms included with the interfaces, etc.). The interfaces may include required information entries, optional information entries, menus, buttons, checkboxes, and the like. The recovery engine 118 may be further configured to populate certain data into the interfaces based on the initial request from the recovering entity (e.g., issuer data associated an issuer of the account device 114, etc.). Upon the completion of the input of data to the interfaces by the recovering entity, and potentially a submission by the recovering entity, the recovery engine 118 is configured to record the recovery data in the recovery data structure 120. The submission, or parts thereof, may also be provided to other entities in the system 100, such as the issuer 108, to thereby notify the issuer 108 of the recovery and substantially complete the recovery process.

Additionally, the recovery engine 118 is configured to generate fee entries for the recovered account device 114, and append the fee entries to a billing data structure (e.g., as part of the recovery data structure 120, etc.). The fee entries reflect the exchange of fees between the recovering entity, the issuer, etc., which is potentially an incentive for the recovering entity to recover the account device 114 and further to report it. The recovery engine 118 is also configured to submit a billing file for processing, whereby fees are debited and/or paid according to the fee entries. It should be understood that in one or more embodiments, the recovery engine 118 may include multiple parts, separated into different computing devices, with one part of the recovery engine 118 coordinating the reporting of recovered account devices, and another part of the recovery engine 118 coordinating the fees.

Further, the recovery engine 118 is configured to notify issuers associated with recovered account devices (e.g., the issuer 108 associated with the account device 114, etc.) that the account devices have been recovered, and removed from circulation, as appropriate. Such notifications may be implemented via a web-based application, website, etc. through which the issuers can access the recovery engine 118 and identify the necessary account devices to be recovered, set preferences for recovery, and set preferences for notification, etc. What's more, the issuers may also be able to review account devices that have recently been recovered, or account devices that have been recovered during a particular time period.

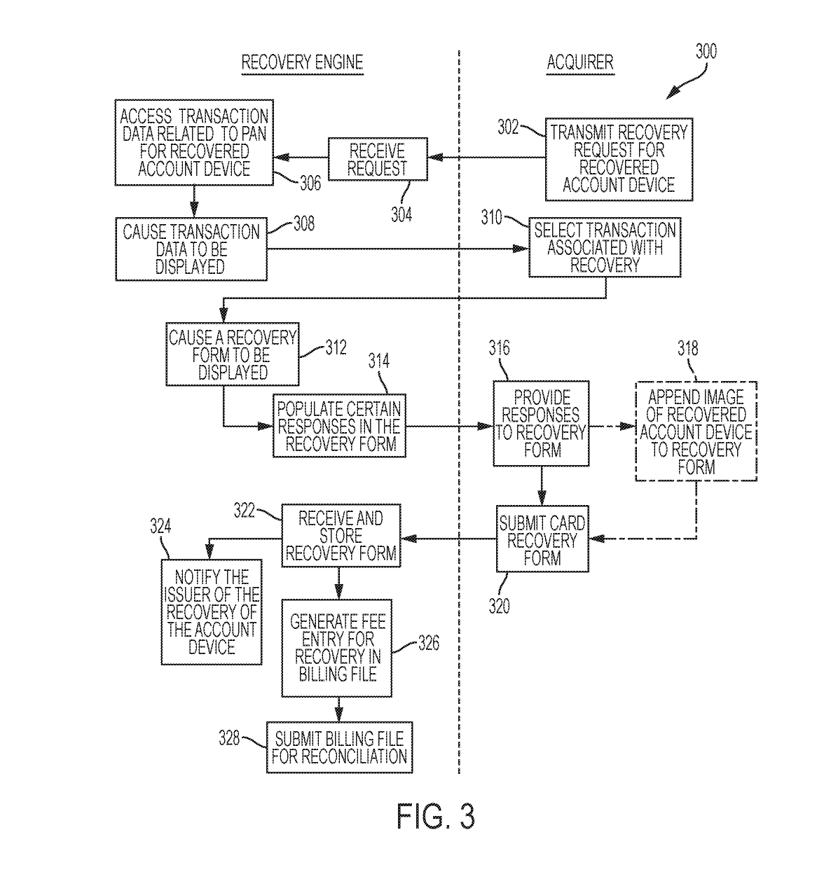

FIG. 3 illustrates an exemplary method 300 for use in reporting recovery of an account device, in accordance with the description herein. The method 300 is described with reference to the recovery engine 118 as implemented via the payment network 106, and further with reference to the computing device 200. It should be appreciated, however, that the methods herein are not limited to the system 100 and computing device 200, and conversely that the systems and computing devices herein are not limited to the method 300.

In the method 300, when the account device 114 is identified as being compromised, it is designated for recovery, for example, by the issuer 108 (and is potentially reported to the recovery engine 118 by the issuer 108). Then, when the consumer 112 attempts to use the account device 114 at the merchant 102, the merchant 102 recovers the account device 114 and provides it to the acquirer 104, which then reports the recovery. Alternatively, when the consumer 112 attempts to use the account device 114 at the ATM 116, the ATM 116 captures the account device 114 and the bank associated with the ATM 116 (i.e., the acquirer 104 in the following description) facilitates the reporting. It should be appreciated that other entities (e.g., the merchant 102 directly, etc.) may coordinate reporting and/or report the recovery of the account device 114 in various other embodiments.

In either of the above cases, once the account device 114 is recovered/captured (either by the merchant 102 or the ATM 116) in the method 300, the acquirer 104 generates a recovery request for the account device 114 and transmits the request to the recovery engine 118, at 302. In turn, the recovery engine 118 receives the request, at 304.

In particular in the method 300, the acquirer 104 interacts with the recovery engine 118 via the payment network 106 through a website, or other web-based application, to generate the recovery request (e.g., whereby the acquirer 104 logs into the website, etc.). Within the website, the acquirer 104 is provided the option to report the recovery of the account device 114. Upon selection of the recovery option, the recovery engine 118 causes an interface, including at least one initial recovery form, to be displayed to the acquirer 104 (or more specifically, to an employee of the acquirer 104), for example, at a workstation computing device. The acquirer 104 can then input data associated with the recovery to the recovery form via the interface. In this exemplary embodiment, the request includes the PAN associated with the account device 114 (broadly, an account identifier). In other embodiments, the initial request may not include a PAN or other identifier, where the acquirer 104 or other recovering entity then submits the account identifier at a later time in the reporting process. It should be appreciated that one or multiple interactions may occur between the acquirer 104 and the recovery engine 118, for the acquirer 104 to submit the recovery request (and for the recovery engine 118 to then receive the request).

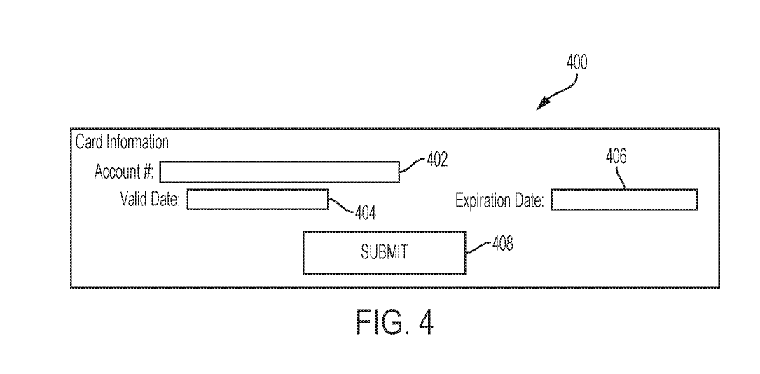

FIG. 4 illustrates an initial recovery form 400 that may be displayed to the acquirer 104 by the recovery engine 118 in connection with the recovery request, as part of an interface associated with a website or other web-based application. The illustrated form 400 includes an account number field 402, which permits the acquirer 104 to fill in the PAN or other identifier of the recovered account device 114. The form 400 also includes fields 404, 406 in which the acquirer 104 is permitted, or potentially required, to enter a valid date on which the account device 114 is first effective, and an expiration date for the recovered account device 114. In addition, or alternatively, the form 400 may include fields (not shown) to allow the acquirer 104 to provide other data such as the consumer's name as shown on the recovered account device 114, a CVV code for the account device 114, or other details available for the account device 114. Upon entering necessary responses, the acquirer 104 then submits the request to the recovery engine 118, via the website or other web-based application, by selecting submit button 408.

With reference again to FIG. 3, after receiving the request (e.g., after receiving initial form 400, etc.), the recovery engine 118 accesses transaction data associated with the account device 114 (based on the PAN for the device 114 as included in the recovery request), at 306, and causes at least a portion of the transaction data to be displayed to the acquirer 104, at 308 (e.g., as part of a filter operation, etc.). The transaction data may include, for example, all transactions associated with the PAN and performed within a predefined interval, for example, the last 15 days, 30 days, or some other interval, etc. In one example, only transactions for which an authorization advice is provided (e.g., including a 0120 message consistent with the ISO 8583 standard, etc.) may be caused to be displayed to the acquirer 104. After viewing the transaction data, the acquirer 104 then selects, at 310, the particular transaction during which the account device 114 was recovered, thereby identifying the merchant 102, for example, as involved in the recovery. In at least one embodiment, the recovery engine 118 may omit accessing transaction data associated with the account device 114.

Next, after selecting the particular transaction for which the account device 114 was recovered, the recovery engine 118 causes an interface having another recovery form to be displayed to the acquirer 104, at 312. This recovery form may solicit a variety of additional and/or different responses from the acquirer 104 and, as such, may be different in various embodiments (depending on the underlying facts associated with the recovery and recovering entity).

At 314, the recovery engine 118 populates certain responses into one or more fields of the recovery form, via the interface. The recovery engine 118 may populate all known information into the recovery form, as displayed to the acquirer 104, so that the acquirer 104 is responsible for providing a reduced number of responses to complete the recovery form. In various embodiments, despite population by the recovery engine 118, the responses may be altered by the acquirer 104 when responding to the recovery form. That is, the responses may be editable by the acquirer 104 even when populated by the recovery engine 118. Conversely, in other embodiments, responses populated by the recovery engine 118 may be un-editable. For example, fee and/or reward data populated by the recovery engine 118 may not be editable by the acquirer 104.

The responses populated by the recovery engine 118 in the recovery form (at 314) may be retrieved, for example, from the payment network 106, based on the PAN (or other identifier) of the account device 114 and/or based on the selection of the particular transaction upon which the account device 114 was recovered. As such, the responses populated by the recovery engine 118 may relate to the merchant 102 involved in the transaction during which the account device 114 was recovered, including a name of the merchant 102, a merchant category code (MCC) of the merchant 102, and an address associated with the merchant 102, etc. Likewise, the recovery engine 118 may populate response(s) relating to the issuer 108 associated with the account device 114, including an ICA of the issuer 108, a name of the issuer 108, etc. Further, the recovery engine 118 may also often populate any fields relating to a fee and/or reward for reporting recovery of the account device 114, if included in the recovery form. The fee and/or reward is often set by the acquirer 104 and stored in the data structure 120, and then retrieved, by the recovery engine 118, from the data structure 120, as needed. The fee and/or reward may be different for different acquirers (and/or for different issuers) and/or may be based on the particular recovery entity and/or the payment network 106, etc.

Apart from the responses populated by the recovery engine 118, the acquirer 104 provides, at 316, responses to the remainder of the recovery form, if necessary and/or as applicable.

In addition, the acquirer 104 optionally, as indicated by the dotted lines in FIG. 3, appends an image of the recovered account device 114 to the recovery form, at 318, as additional confirmation that the device 114 has been recovered. So that the issuer 108 may issue an additional account device having the same PAN sometime in the future, for example, the issuer 108 seeks to confirm the account device 114 is recovered and destroyed or otherwise rendered into an unusable state (e.g., unable to be swiped through a card reader, unable to be read by a card reader, etc.). As such, to potentially avoid returning the account device 114 to the issuer 108, yet providing proof of the unusable state of the account device 114, the recovery form may permit the acquirer 104 to render the account device 114 unusable (e.g., by cutting, shredding, or severing the device into multiple pieces, etc.). In response, the acquirer 104 renders the account device 114 unusable and then captures an image (e.g., photographs, photocopies, etc.) of what is left of the account device 114, i.e., an image depicting the account device 114 in an unusable state. In various other embodiments, the acquirer 104 may also (or alternatively) attach other forms/documents to the recovery request including, for example, a certificate from the merchant 102 and/or the acquirer 104 certifying that they have destroyed the account device 114 per issuer instructions, an image of the consumer 112 using the account device 114, other pertinent evidence, etc.

After the acquirer 104 has completed the recovery form, the acquirer 104 submits the recovery form, at 320, to the recovery engine 118, via network 110. In turn, the recovery engine 118 receives the recovery form (and specifically, the responses therein), at 322, and stores the same in the recovery data structure 120 (or another data structure). In connection therewith, and as described in the system 100, the recovery engine 118 may notify the issuer 108 that the account device 114 has been recovered and rendered unusable (e.g., by transmitting a notification to the issuer 108 via the network 110, etc.). In addition (or alternatively), the issuer 108 may be able to access the recovery engine (e.g., via one or more applications, etc.) to review (and potentially confirm) information relating to the recovered account device 114 (e.g., information included in the recovery form, etc.). The issuer 108 can then update its records to confirm that the account device 114 has been recovered.

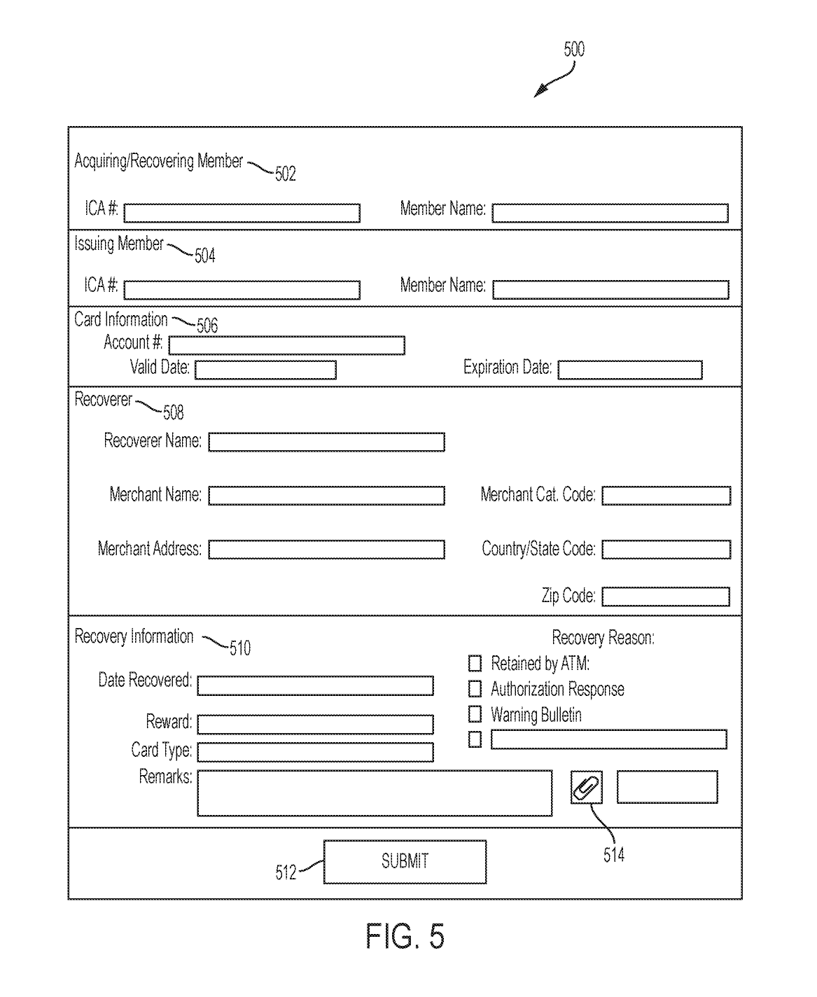

FIG. 5 illustrates an example recovery form 500 that may be displayed to the acquirer 104 by the recovery engine 118 in connection with a recovery request, as part of an interface associated with a website or other web-based application. The recovery form 500 may be displayed to the acquirer 104, for example, as a subsequent page in the interface following completion of the initial recovery form 400. Alternatively, the recovery form 500 may be displayed to the acquirer 104 independent of the initial recovery form 400.

The illustrated recovery form 500 generally includes an acquiring/recovering member section 502, an issuing member section 504, a card information section 506, a recovery entity section 508, a recovery information section 510, and a submit button 512. The acquiring/recovering member section 502 includes a field for an Interbank Card Association (ICA) number associated with the acquirer 104 (i.e., the entity reporting the recovery), and a field for a name of the acquirer 104. The issuing member section 504 also includes an ICA number field and a name field for the issuer 108 (associated with the consumer's payment account for which the account device 114 has been recovered). The card information section 506 includes an account identifier field, which may be directed to the PAN of the recovered account device 114, or some other identifier of the account device 114 or the associated account (e.g., payment account, etc.). The recovery entity section 508 solicits information to identify the merchant 108, for example, where the account device 114 was actually recovered, as well as the particular person that physically recovered the account device 114 (e.g., an employee of the merchant 102, a police officer, etc.). As such, in the illustrated recovery form 500, the recovery entity section 508 includes fields that solicit a name of the individual that recovered the account device, a name and address of the merchant 102, and a MCC for the merchant 102.

The recovery information section 510 of the recovery form 500 solicits information specific to the recovery of the account device 114. The section 510 includes additional fields directed to the date of the recovery, a recovery reason, a compensation (broadly, a fee), a card type, and remarks. The date of recovery identifies the date on which the account device 114 was recovered. The recovery reason may include the reason for the account device 114 being recovered, which, as shown, may include different selectable options, i.e., retained by ATM, authorization response, warning bulletin, and other. In other embodiments, recovery forms may include additional or different recovery reasons, including authenticator, non-hologram, code 10—Merchant suspicious, etc. The compensation may include a reward, such as, for example, a fee to be paid to the particular recovering entity/individual, for example, as identified in section 508. The remarks section permits the acquirer 104 to provide any additional remarks about the recovering entity, the recovery, etc. In addition, the recovery information section 510 includes an attachment button 514 that permits the acquirer 104 to provide evidence of the recovered account device 114, including, for example, an image of the account device 114 and/or an image of the account device 114 rendered unusable.

In addition to the multiple fields and sections, the recovery form 500 may include designations, such as, for example, an asterisk proximate to a field indicating that the field is required to be filled, prior to submission. The fields required to be filled, or not, may be defined by the recovery engine 118, the issuer 108 associated with the account device 114, and/or another entity. Once the recovery form 500 is complete, the acquirer 104 can submit the form to the recovery engine 118 via, the website or other web-based application, by selecting the submit button 512.

Again, it should be understood that the illustrated sections of the recovery form 500 are included as exemplary sections and do not limit a recovery form that may be used as described herein. Different recovery forms may include, for example, more, fewer, or different sections, organized in the same, similar, or different manners. And, a recovery form may include multiple pages, tabs, or the like for the purpose of collecting necessary and/or optional information, in a particular sequence, or not, to process a card recovery event.

Referring again to FIG. 3, after receiving the completed recovery form from the acquirer 104, the recovery engine 118 notifies the issuer 108, at 324, that the account device 114 has been recovered, and removed from circulation. As described above in connection with the system 100, the issuer 108 may be able to access the recovery engine 118 via a web-based application, website, etc., through which the issuer 108 can receive the notification or specify delivery of the notification (e.g., via email, SMS, etc.). What's more, through the web-based application, website, etc., the issuer 108 may also be able to review account devices (including the account device 114) that have recently been recovered.

The recovery engine 118 then generates a fee entry, at 326, for the recovery of the account device 114, within a billing file stored in the recovery data structure 120. The fee entry includes a fee directed to the acquirer 104, which compensates the actual recovering entity (e.g., the merchant 102, etc.) for reporting the recovered account device 114. In connection therewith, the fee debits from the issuer 108 and is paid to the acquirer 104. In one or more embodiments, the fee entry includes a fee directed to the payment network 106 (and/or the recovery engine 118) that compensates the payment network 106 for participating in reporting the recovered account device 114. In one example, a fee entry includes a $15 administrative fee for the acquirer 104, a $10 processing fee for the payment network 106, and a further reward fee of $1-110 for the recovering entity (e.g., an employee of the merchant 102, etc.). The fee entry may then include a debit to the issuer 108 for the total amount of fees paid. In this example, the fee entry further includes a fee part to reimburse the acquirer 104 for any interchange fees associated with the recovery of the account device 114. It should be appreciated that a variety of different fees may be debited from some entity and paid to other entities, etc. The fee entry may further include an identifier associated with the account device 114 and/or the recovering entity, or other aspect of the recovery, to permit auditing of the fees at a later time, if necessary or desired. At one or more regular, or irregular intervals, the recovery engine 118 submits, at 328, the billing file for reconciliation, thereby causing the fees to be settled among the entities involved.

In view of the above, the systems and methods herein may enable a recovering party of a payment account card or other payment device to accurately and efficiently complete the payment device recovery process through the use of a generated electronic and/or web-based form. The form may include fields and/or data that are pre-populated to reduce the effort and time required to complete the form. By providing recovering parties with a sleek, dynamic, electronic form, the recovery process is substantially clarified and improved.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transforms a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) receiving a request to report recovery of an account device, the request including an identifier associated with the account device; (b) causing an interface to be displayed to a recovering entity of the account device in response to the request, the interface including multiple data fields relating to the recovery of the account device; (c) populating at least a portion of the multiple data fields based on the identifier associated with the account device; (d) receiving, via the interface, a submission to the multiple data fields by the recovering entity; (e) receiving, via the interface, an image of the account device in an unusable form; and (f) storing the submission and image to a data structure, as proof that the account device has been recovered and is unusable in further transactions.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in processing recovery of an account device associated with a payment account, so as to inhibit further use of the account device in transactions, the method comprising:
receiving, by a computing device, a request to report recovery of an account device, the request including an identifier associated with the account device;
causing, by the computing device, an interface to be displayed to a recovering entity of the account device in response to the request, the interface including multiple data fields relating to the recovery of the account device;
populating, by the computing device, at least a portion of the multiple data fields based on the identifier associated with the account device;
receiving, by the computing device, via the interface, a submission to the multiple data fields by the recovering entity;
receiving, by the computing device, via the interface, an image of the account device in an unusable form; and
storing the submission and image to a data structure, as proof that the account device has been recovered and is unusable in further transactions.

2. The computer-implemented method of claim 1, further comprising transmitting, by the computing device, a notification to an issuer of the account device confirming the recovery of the account device.

3. The computer-implemented method of claim 1, wherein the multiple data fields include multiple recovery entity fields associated with the recovering entity; and
further comprising populating, by the computing device, at least a portion of the multiple recovering entity fields based on the request.

4. The computer-implemented method of claim 3, wherein the multiple data fields further include at least one field associated with the issuer; and
further comprising populating, by the computing device, the at least one field associated with the issuer based on the identifier associated with the account device.

5. The computer-implemented method of claim 1, wherein the account device is one of a credit card, a debit card, and a fob; and
wherein the unusable state includes the account device severed into multiple pieces.

6. The computer-implemented method of claim 1, wherein populating at least a portion of the multiple data fields includes populating at least one of an acquirer identifier, an issuer identifier, a recovery date, and a recovery reason prior to causing the interface including the multiple data fields to be displayed to the recovering entity.

7. The computer-implemented method of claim 1, further comprising:
appending, by the computing device, at least one fee entry to a billing file associated with the recovery of the account device; and
submitting, by the computing device, the billing file for reconciliation, thereby causing the at least one fee entry to be settled among at least the recovering entity and an issuer of the account device.

8. The computer-implemented method of claim 7, wherein the recovering entity includes an acquirer, a merchant, and/or an automated teller machine (ATM).

9. The computer-implemented method of claim 7, wherein submitting the billing file for reconciliation includes submitting the billing file to a payment network associated with processing transactions involving payment accounts issued by the issuer.

10. The computer-implemented method of claim 1, wherein the multiple data fields include at least one required field, and wherein the submission includes a submission to the at least one required field.

11. A non-transitory computer readable storage media including computer executable instructions for reporting recovery of account devices, which when executed by at least one processor, cause the at least one processor to:
access a data structure and search in the data structure for a primary account number (PAN) associated with an account device, in response to a request reporting recovery of the account device;
populate data from the data structure into a recovery form generated in response to the request, when the PAN is included in the data structure;
cause the recovery form, with the populated data, to be displayed to a recovering entity associated with the request;
receive and verify a submission of the recovery form from the recovering entity; and
when the submission is verified, generate a fee entry in a billing file based on the submission, whereby the fee entry, when paid, compensates the recovering entity for reporting the recovered account device.

12. The non-transitory computer readable storage media of claim 11, wherein the computer executable instructions, when executed by the at least one processor, further cause the at least one processor to submit the billing file for settlement after a defined interval.

13. The non-transitory computer readable storage media of claim 11, wherein the data from the data structure includes at least an issuer ID for an issuer of the account device.

14. The non-transitory computer readable storage media of claim 13, wherein the submission of the recovery form includes responses, by the recovering entity, to the recovery form; and
wherein:
at least one of the responses includes an image of the recovered account device, the image depicting the account device in an unusable state, whereby physically returning the recovered account device to an issuer of the account device is omitted; and/or
at least one of the responses includes a certification that the account device has been recovered.

15. The non-transitory computer readable storage media of claim 14, wherein the instructions, when executed by the at least one processor, cause the at least one processor to transmit a notification to the issuer of the account device confirming the recovery of the account device.

16. The non-transitory computer readable storage media of claim 15, wherein the notification includes the image of the recovered account device and/or the certification.

17. A system for use in reporting recovery of an account device, the system comprising:
a payment network including at least one computing device, wherein the at least one computing device is configured to:
receive a request regarding recovery of an account device in association with use of the account device in a transaction, the request including an identifier associated with the account device;
identify, in a data structure, transaction data for the transaction, based on the identifier associated with the account device;
request recovery data for the account device from a recovering entity, based at least in part on the transaction data for the transaction; and
when a response to the recovery data is received from the recovering entity:
generate a fee entry in a billing data structure stored in said at least one computing device; and
notify an issuer associated with the payment device of the recovery; and
cause the fee entry in the billing data structure to be processed, whereby the recovering entity is compensated for reporting the recovery.

18. The system of claim 17, wherein the account device is a payment device; and
wherein the fee entry includes at least a fee directed to the recovering entity, a fee directed to the payment network, and a debit directed to the issuer.

19. The system of claim 17, wherein the at least one computing device is further configured to reject the response from the recovering entity, unless an image of the account device is included with the response.

20. The system of claim 17, wherein, in connection with requesting recovery data for the account device, the at least one computing device is configured to cause recovery form to be displayed at a computing device associated with the recovering entity, the recovery form including multiple data fields soliciting the recovery data.
